(19) United States
(12) Patent Application Publication
(10) Pub. No.: US 2018/0349354 A1
(43) Pub. Date: Dec. 6, 2018

(54) NATURAL LANGUAGE INDEXER FOR VIRTUAL ASSISTANTS

(71) Applicant: INTEL CORPORATION, SANTA CLARA, CA (US)

(72) Inventors: JESUS GONZALEZ, Mairena del Aljarafe (Sevilla) (ES); GUILLERMO PEREZ, Sevilla (ES); MARIA PILAR MANCHON PORTILLO, Los Altos, CA (US); GABRIEL AMORES, Sevilla (ES)

(73) Assignee: INTEL CORPORATION, SANTA CLARA, CA (US)

(21) Appl. No.: 15/532,441

(22) PCT Filed: Jun. 29, 2016
(86) PCT No.: PCT/US16/39967

§ 371 Date: Jun. 1, 2017

(51) Int. Cl. G06F 17/27; G06F 17/30

(52) U.S. Cl. CPC G06F 17/2785; G06F 17/30672; G06F 17/271

(57) ABSTRACT

One embodiment provides an apparatus. The apparatus includes crawler logic, indexer logic, natural language understanding (NLU) parser logic and a content data store. The crawler logic is to retrieve content. The indexer logic is to extract at least one of a sentence and/or a phrase and to identify a key term and a content element location identifier. The natural language understanding (NLU) parser logic is to classify the sentence and/or phrase based, at least in part, on semantic information and/or based, at least in part, on syntactic information. At least one of the indexer logic and/or the NLU parser logic is to store a content data record including a key term identifier, at least one of a semantic classification identifier and/or a syntactic classification identifier and the content element location identifier to the content data store.

### FIELD

The present disclosure relates to a natural language indexer, in particular to, a natural language indexer for virtual assistants.

### BACKGROUND

Virtual assistants, also known as intelligent digital assistants, are applications that run on computing devices and may be used to assist users in finding information. A user may request information by providing a natural language query as speech and/or text. The virtual assistant may then interpret the query, identify key terms, initiate a search based, at least in part, on the identified key terms, receive one or more responses and provide selected responses to the user via speech and/or text.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a natural language system consistent with several embodiments of the present disclosure;

FIG. 2 illustrates one example constituency parsing tree, consistent with one embodiment of the present disclosure;

FIG. 3 illustrates one example dependency parsing tree, consistent with one embodiment of the present disclosure;

FIG. 4 is a flowchart of content indexing operations according to various embodiments of the present disclosure; and

FIG. 5 is a flowchart of content retrieval operations according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

A virtual assistant (VA) may be configured to search globally (“general purpose VA”) or may be associated with a host system (“domain specific VA”). The domain specific VA may be configured to search one or more host websites (including linked webpages) and/or stored information associated with the host system. A host website may include, but is not limited to, a business-related website, a company website, an e-commerce website, a digital newspaper, an online seller, an online auction, an informational website, etc. The stored information may include, but is not limited to, documents, website source information (e.g., product and/or service descriptions, inventory information, customer reviews, etc.), etc. Domain specific VAs may be configured to aid user navigation in the host websites and/or help the user to retrieve information, acquire products (i.e., goods and/or services) and/or resolve issues.

Content of host websites may be updated relatively frequently, using, for example, content management systems. Some host websites may allow contribution to content by users (“user feedback”), for example, comments, product and/or service reviews, etc. Such user feedback may be provided periodically and/or intermittently. Content may include text and/or graphics. Text may include, words, phrases, sentences and/or combinations thereof. The content may be indexed to facilitate searching.

VAs may be configured to receive natural language queries. Natural language queries may be configured as statements or questions. The natural language query may be parsed and at least key terms may be extracted. Searches using extracted key terms may produce results that may or may not be relatively closely related to the query.

Generally, this disclosure relates to a natural language indexer for domain specific virtual assistants. An apparatus, method and/or system are configured to retrieve content, to extract words, phrases and/or sentences and to classify the words, phrases and/or sentences. For example, natural language parser (NLU) logic may be configured to classify the words, phrases and/or sentences. Classification may include identifying object information, semantic information and/or syntactic information.

Object information may generally include noun type object descriptors that correspond to, for example, product names, service names, event names, etc. At least some object descriptors may correspond to key terms, i.e., may be relatively more important than other words and/or phrases in a content element. Semantic information and/or syntactic information may be associated with one or more key terms. Semantic information is configured to provide meaning and/or context to the key terms. Semantic information may include, but is not limited to, sentiment descriptors, adjective descriptors, synonyms to key terms, frequency that a key term appears in a content element, relative importance of the key term in the content element, location of the key term in the content element, etc. A content element may include a document, a webpage and/or a portion thereof. Thus, content may include one or more content elements. Syntactic information may include, but is not limited to, word order, part of speech, etc.

The apparatus, method and/or system may be further configured to store content data, including one or more content data records, to a content data store. The content data may include object data, semantic data and related content location identifiers, e.g., URL (universal resource locator) links. The object data may include identifiers related to key terms. The semantic data may include classification identifiers related to semantic information and/or syntactic information. The content data may be indexed to facilitate searching based, at least in part, on one or more of key terms, semantic information and/or syntactic information.

Natural language queries may be received from a user device. The NLU parser logic may be configured to parse the received user natural language query and to extract key terms, semantic information and/or syntactic information. The extracted key terms, semantic information and/or syntactic information may then be utilized to search the content data store. Utilizing the semantic information and/or syntactic information may yield relatively more directed search results compared to utilizing key terms alone. Thus, a user experience associated with the VA may be enhanced.

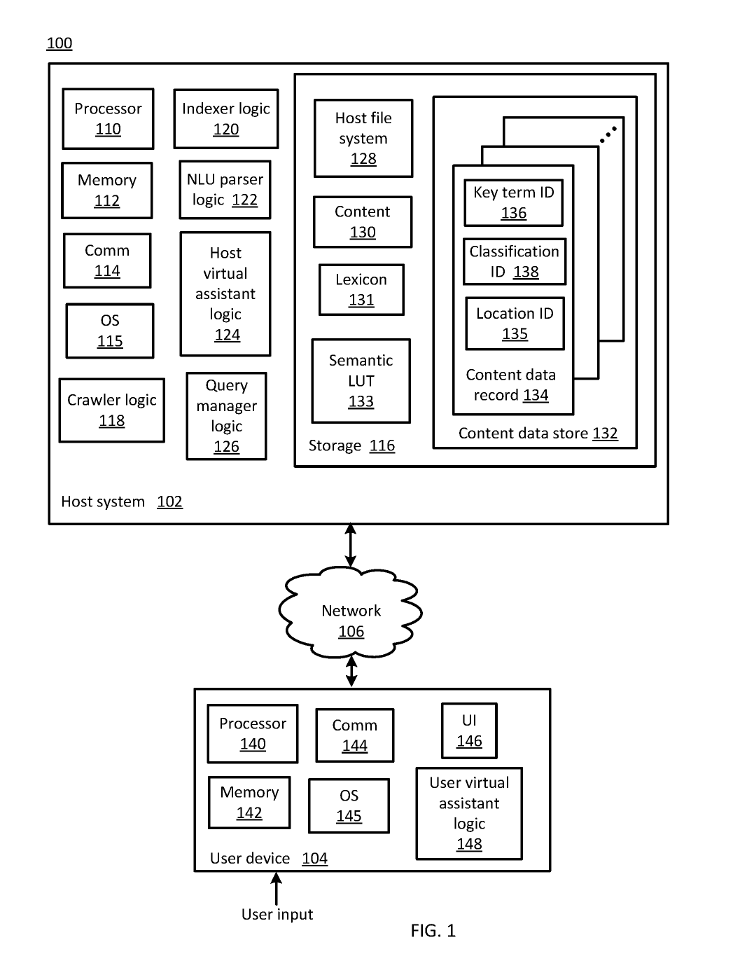

FIG. 1 illustrates a functional block diagram of a natural language system 100 consistent with several embodiments of the present disclosure. System 100 includes a host system 102, a user device 104 and a network 106. Host system 102 may include, but is not limited to, a server, a workstation computer, a network of servers and/or workstations, a portion of a cloud-based computing system and/or other known and/or after developed host systems, etc. User device 104 may include, but is not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; a computing device (e.g., a server, a workstation computer, a desktop computer, a laptop computer, a tablet computer (e.g., iPad®, GalaxyTab® and the like), a phablet computer, an ultraportable computer, an ultramobile computer, a netbook computer and/or a subnotebook computer; and/or other known and/or after developed user devices, etc. User device 104 may be coupled to host system 102 wired and/or wirelessly via network 106.

Host system 102 includes a processor 110, memory 112, a communication interface 114, an operating system (OS) 115 and storage 116. Host system 102 may include crawler logic 118, indexer logic 120, natural language understanding (NLU) parser logic 122, host virtual assistant (VA) logic 124 and/or query manager logic 126. Storage 116 is configured to store host file system 128, content 130, lexicon 131, semantic lookup table (LUT) 133 and/or content data store 132. Host file system 128 is configured to store, for example, documents, etc., related to host system 102. Content data store 132 may contain one or more content data records, e.g., content data record 134. Each content data record, e.g., content data record 134, may include a plurality of fields. For example, the fields may be configured to contain a key term identifier 136, a classification identifier 138 and a content element location identifier 135. User device 104 includes processor 140, memory 142, communication interface 144, OS 145 and user interface (UI) 146. User device 104 may include user virtual assistant (VA) logic 148.

Processors 110, 140 may include one or more processing units and are configured to perform operations of host system 102 and user device 104, respectively. Communication interfaces 114, 144 are configured to provide communication capability to host system 102 and user device 104, respectively. Such communication may be wired and/or wireless and may comply and/or be compatible with one or more communication protocols, as described herein.

User interface 146 is configured to capture user inputs and to provide outputs to the user. For example, user interface 146 may include, but is not limited to, a keyboard, a keypad, a mouse, a display, a touch sensitive display, a microphone, a speaker, etc., and/or combinations thereof. User interface 146 may further include logic configured to convert captured speech to text or to convert text to speech for output to the user.

Crawler logic 118 is configured to retrieve content and to store content in content store 130. Crawler logic 118 may comply and/or be compatible with one or more crawler specifications and/or protocols. For example, crawler logic 118 may comply and/or be compatible with Apache® Nutch™, release 2.3, released Jan. 22, 2015, by the Apache® Software Foundation, and/or later and/or related versions of this specification. In another example, crawler logic 118 may comply and/or be compatible with Scrapy Documentation, Release 1.0, released June, 2015, by Scrapinghub, Ltd and/or Scrapy developers, and/or later and/or related versions of this specification. Crawler logic 118 may be configured to identify content that has changed since a prior crawl activity and to retrieve changed content. For example, crawler logic 118 may correspond to a focused crawler. A focused crawler is a web crawler configured to collect webpages and/or other content that satisfy a specified property. A web crawler is a bot that is configured to automatically browse at least a portion of the World Wide Web starting with one or more URLs (“seeds”), identifying hyperlinks, adding the hyperlinks to the initial URLs and is further configured to copy discovered content. The specified property may include, for example, selected topics (e.g., selected key terms), semantic information, etc. A focused crawler may be further configured to constrain its activities to a specified domain, e.g., a host website, a portion of a host file system structure, etc. Thus, crawler logic 118 may be configured to retrieve content related to host system 102.

Content may be retrieved from host website(s), host system memory 112 and/or storage 116, e.g., host file system 128. For example, crawler logic 118 may be configured to initiate a search for content based, at least in part, on a root directory and/or based, at least in part, on a URL of a host website. Thus, the root directory and/or the URL of the host website may be related to a seed. Crawler logic 118 may be further configured to detect links to other webpages and to retrieve content from the linked webpages. Crawler logic 118 may be configured to copy retrieved content for storage in the content store 130. Content may include, but is not limited to, documents (e.g., html (hypertext markup language) format, docx (Microsoft® Word® document) format, pdf (portable document format) format, etc.), webpage contents (e.g., text), etc. Content may include websites that are not publicly indexed, i.e., “URL deep”. Content may be associated with an address including, but not limited to, webpage addresses (e.g., URL), paths to stored files, etc., configured to identify a location of the associated content.

Indexer logic 120 is configured to index retrieved content. Indexing retrieved content may include extracting phrases and/or sentences from stored content 130 using, for example, segmentation techniques. Indexing retrieved content may further include identifying a key term and a location identifier, e.g., address, associated with a retrieved content element. Content 130 may include one or more content elements. Segmentation techniques are configured to identify sentences and/or phrases. For example, segmentation techniques may include statistical decision-making and may rely on dictionaries and/or machine learning techniques. Machine learning techniques may be domain specific, thus targeting the host system domain. Indexer logic 120 is further configured to associate key terms with the content element location identifier. Location identifiers may include, but are not limited to, URLs, a path to a file, including a file name, etc. Key terms may generally include noun type object descriptors (i.e., objective information) that correspond to, for example, product names, service names, event names, etc.

NLU parser logic 122 is configured to classify extracted content based, at least in part, on semantic information and/or syntactic information and to generate corresponding semantic data. Semantic data may include one or more semantic classification identifiers and/or syntactic classification identifiers. NLU parser logic 122 and/or indexer logic 120 may be configured to associate semantic data with corresponding key terms and content location identifiers. NLU parser logic 122 and/or indexer logic 120 may be further configured to store a content data record to the content data store 132. The content data record, e.g., content data record 134, may include a key term identifier, at least one of a semantic classification identifier and/or a syntactic classification identifier and the content element location identifier.

Semantic information is configured to provide meaning and/or context to an associated key term and/or to a phrase and/or sentence that includes the associated key term. Semantic information may include, but is not limited to, sentiment descriptors, adjective type descriptors, subject matter indicators, etc. Subject matter indicators may include, but are not limited to, whether a sentence and/or phrase includes an expression of sentiment related to an object (i.e., key term), whether a sentence and/or phrase is a request for information, whether a sentence and/or phrase is a recommendation related to an object, whether a sentence and/or phrase is a request for a recommendation related to an object, etc. Semantic information may further include a score relative to other semantic information determined based, at least in part, on a frequency of occurrence of a descriptor, a relative importance in a source of the content (e.g., location on a webpage), header information, etc. Syntactic information may include, but is not limited to, type of phrase or sentence (e.g., statement, question), word order, punctuation, location of punctuation in a phrase and/or sentence, etc.

Semantic data includes semantic classification identifiers related to semantic information and/or syntactic classification identifiers related to syntactic information. For example, the semantic classification identifiers and syntactic classification identifiers may be numeric or alphanumeric. Thus, classifying extracted content to generate semantic data may include analyzing semantic information and/or syntactic information and selecting and/or determining a corresponding classification identifier.

NLU parser logic 122 may be configured to implement a NLU parsing technique to classify the extracted content. NLU parsing techniques may include, but are not limited to, constituency parsing and/or dependency parsing. Both constituency parsing and dependency parsing are configured to utilize a tree structure for parsing a phrase and/or a sentence.

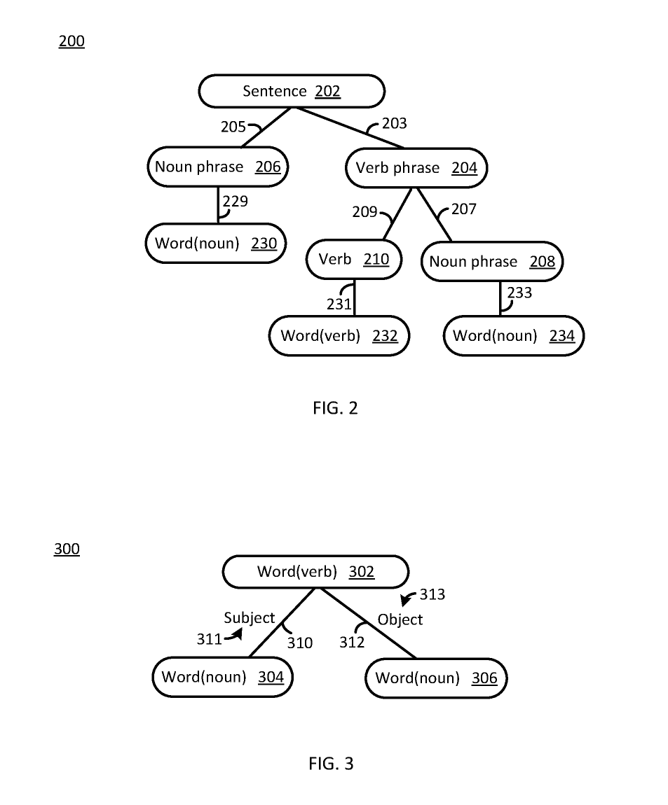

FIG. 2 illustrates one example constituency parsing tree 200, consistent with one embodiment of the present disclosure. Example constituency parsing tree 200 corresponds to a sentence that includes a subject, a verb and an object, e.g., “John sees Bill”. Constituency parsing is configured to break an input sentence into one or more sub phrases. Terminals, i.e., terminations, in the tree correspond to words in the input sentence and non-terminals in the tree correspond to types of phrases. Edges, e.g., branches, in a constituency parsing tree may be unlabeled.

Thus, example constituency parsing tree 200 includes a type of input, e.g., sentence 202, at an apex. Two branches 203, 205 extend from apex 202 to non-terminals 204 and 206. Non-terminals 204 and 206 each correspond to types of phrases, e.g., noun phrase 206 and verb phrase 204. For the example sentence “John sees Bill”, “John” is included in noun phrase 206 and “sees Bill” is included in verb phrase 204. Two branches 207, 209 extend from verb phrase 204 to non-terminals, noun phrase 208 and verb 210, respectively. For the example sentence “John sees Bill”, “sees” is included in verb 210 and “Bill” is included in noun phrase 208. Branch 229 extends from noun phrase non-terminal 206, branch 231 extends from verb non-terminal 210 and branch 233 extends from noun phrase non-terminal 208. Each branch 229, 231, 233 terminates at a respective terminal 230, 232, 234. Each terminal 230, 232, 234 corresponds to a word, e.g., a noun or a verb. Thus, for the example sentence “John sees Bill”, “John” corresponds to word (noun) 230, “sees” corresponds to word (verb) 232 and “Bill” corresponds to word (noun) 234. Thus, a constituency parsing tree may be utilized to break an input sentence and/or phrase into a plurality of sub phrases.

FIG. 3 illustrates one example dependency parsing tree 300, consistent with one embodiment of the present disclosure. Similar to example 200, example dependency parsing tree 300 corresponds to a sentence that includes a subject, a verb and an object, e.g., “John sees Bill”. Dependency parsing is configured to connect words in a sentence and/or phrase to be parsed according to relationships between the words. Each vertex, e.g., node, in a dependency parsing tree is configured to represent a word. Child nodes correspond to words that are dependent on a parent node. Edges, e.g., branches, are labeled according to a relationship between a parent node and a corresponding child node.

Thus, example dependency parsing tree 300 includes a parent node 302 and two child nodes 304, 306. A first child node 304 is connected to the parent node 302 by a first edge 310. A second child node 306 is connected to the parent node 302 by a second edge 312. Each edge 310, 312 has a corresponding label 311, 313, configured to represent a relationship between the respective child node 304 or 306 and the parent node 302. For a sentence that includes a subject, a verb and an object, e.g., “John sees Bill”, the parent node 302 corresponds to the verb, the first child node 304 corresponds to the subject and the second child node 306 corresponds to the object. In other words, “sees” corresponds to the parent node 302, “John” corresponds to the first child node 304 and “Bill” corresponds to the second child node 306. “John” is related to “sees” as the subject 311 and “Bill” is related to “sees” as the object 313. Thus, a dependency parsing tree may be utilized to connect, i.e., map, words in the dependency parsing tree according to relationships between words in an input sentence and/or phrase.

Thus, extracted content may be classified by NLU parser logic 122 using an NLU parsing technique. Extracted content may include one or more key terms and may further include one or more descriptors, as described herein. Each key term may have synonyms and each descriptor may also have synonyms. Key terms, descriptors and associated synonyms may be stored, for example, in lexicon 131. The key terms, descriptors and associated synonyms may be indexed by identifiers. Thus, each identifier may be associated with a respective group of synonymous terms or descriptors.

NLU parser logic 122 and/or indexer logic 120 may be configured to determine a corresponding identifier for each key term and descriptor associated with extracted content and/or a content element. Semantic LUT (lookup table) 133 may be configured to store subject matter indicator descriptors associated with corresponding semantic classification identifiers. Semantic LUT 133 may be further configured to store syntactic information descriptors associated with syntactic classification identifiers. NLU parser logic 122 may be configured to determine one or more semantic and/or syntactic classification identifiers based, at least in part, on semantic information and based, at least in part, on syntactic information. Semantic LUT 133 may be further configured to store the score, thus, score may correspond to a semantic classification identifier. The identifier(s) may then be associated with the corresponding location identifier and stored to content data store 132.

Thus, as a result of the operations of crawler logic 118, indexer logic 120 and NLU parser logic 122, content data store 132 may contain a plurality of content data records, e.g., content data record 134. Each content data record (e.g., content data record 134) may include a key term identifier (e.g., key term identifier 136), one or more classification identifiers (e.g., classification identifier 138) and a content element location identifier (e.g., location identifier 135). The location identifier may be, for example, a URL or a file system path, that points to the storage location of the content element that is the source of the key term and semantic and/or syntactic information that corresponds to the key term identifier and classification identifier(s). One content element may be associated with one or more content data records.

Initially, crawler logic 118, indexer logic 120 and NLU parser logic 122 may generally be configured to generate content data and to store the content data records to content data store 132. Crawler logic 118, indexer logic 120 and NLU parser logic 122 are configured to update content data contained in content data store 132 intermittently and/or periodically. Updating content data may be configured to capture changes in content since a prior crawl, as described herein. For example, content data may be updated in response to an event. Events may include, but are not limited to, changes and/or additions to host websites, host webpages, customer feedback, etc. In another example, content data may be updated at an expiry of a time interval. A duration of the time interval may be related to a type of host (i.e., type of information) associated with a host system. For example, the duration of the time interval may be on the order of ones of minutes, tens of minutes or ones of hours. Thus, content data may be updated without user intervention.

Thus, changes to, additions to, and/or deletions from, host content may be captured and indexed. Key terms, semantic information and/or syntactic information associated with the key terms may be extracted and key term identifiers, classification identifiers and associated location identifiers may be stored to the content data store 132 in one or more content data records, e.g., content data record 134. The semantic data may then be utilized to enhance accuracy of search results, as described herein. The changes, additions and/or deletions may be captured and/or indexed in an “off-line” process. As used herein, off-line means asynchronous to and independent of timing of a user query.

User device 104 may then be utilized by a user to access host system 102 via network 106. User device 104 may be configured to receive user input, e.g. speech and/or text, via user interface 146. Operating system (OS) 145 may be configured to recognize the user input and convert the user input to a corresponding digital representation. User VA logic 148 may be associated with host system 102 and/or host VA logic 124. The received and recognized user input may be provided to host VA logic 124 by user VA logic 148 via network 106, communication interface 114 and communication interface 144.

Host VA logic 124 may then be configured to provide the user input to NLU parser logic 122. NLU parser logic 122 is configured to parse the user input to extract and/or identify user key terms, user semantic information and/or user syntactic information. NLU parser logic 122 may then be configured to utilize lexicon 131 and/or semantic LUT 133 to determine corresponding user keyword identifiers and/or user classification identifiers that correspond to the user key term(s), user semantic information and/or user syntactic information. The user key term identifiers and user classification identifier(s) may then correspond to a parse result. The parse result may be provided to query manager logic 126.

Query manager logic 126 is configured to construct one or more queries based, at least in part, on the received parse result. Each query may include a respective query expansion. As used herein, query expansion corresponds to a combination of user key term identifiers, user semantic classification identifiers and/or user syntactic classification identifiers. The query expansions may be configured to broaden a query to increase the likelihood of finding corresponding content data. For example, for a key term identifier A and classification identifiers B and C, query manager logic 126 may construct queries that include A and B and C, A and B or C, A and B, A and C, etc.

Query manager logic 126 is configured to apply each query to content data store 132 to identify target content data record(s). Query manager logic 126 may be configured to search one or more fields of content data store 132. For example, query manager logic 126 may be configured to search the content data store 132 for stored a host key term identifier that corresponds to the user key term identifier. Query manager logic 126 may be further configured to search the content data store 132 for semantic classification identifiers and/or syntactic classification identifiers that correspond to the user semantic classification identifiers and/or the user syntactic classification identifiers. Target content data may then include content data records that correspond to the user key term identifiers, user semantic classification identifiers and/or user syntactic classification identifiers. Query manager logic 126 may be configured to retrieve one or more content element location identifiers associated with the target content data. The retrieved content element identifiers may then be provided, by the query manager logic 126, to the host VA logic 124. The host VA logic 124 may then provide the retrieved content element location identifiers and/or associated content to the user VA logic 148.

If the host VA logic 124 provides the retrieved content element location identifiers, the user VA logic 148 may then retrieve the associated content using the content element location identifiers. The user VA logic 148 may then provide the associated content to the user via, e.g., UI 146.

Thus, changes to, additions to, and/or deletions from, host content that have been captured and indexed “off-line” may be available to the host VA logic 124. The semantic information and/or syntactic information may be utilized to enhance accuracy of search results. The user query may correspond to an “online” process. As used herein, online means in response to a user query and relatively close in time to receiving the user query. “Relatively close in time” corresponds to within ones of seconds, e.g., within one second.

Thus, crawler logic 118 is configured to retrieve content from the host system 102 and indexer logic 120 is configured to extract words, phrases and/or sentences from the retrieved content. NLU parser logic 122 is configured to classify the words, phrases and/or sentences. The indexer logic 120 and/or NLU parser logic 122 are further configured to store content data, including one or more content data records, to a content data store.

Natural language queries may be received from a user device, e.g., user device 104. NLU parser logic 122 is further configured to parse the received user natural language query and to extract key terms, semantic information and/or syntactic information. The extracted key terms, semantic information and/or syntactic information may then be utilized by query manager logic 126 to search the content data store 132. Utilizing the semantic information and/or syntactic information may yield relatively more directed search results compared to utilizing key terms alone. Thus, a user experience associated with the VA may be enhanced.

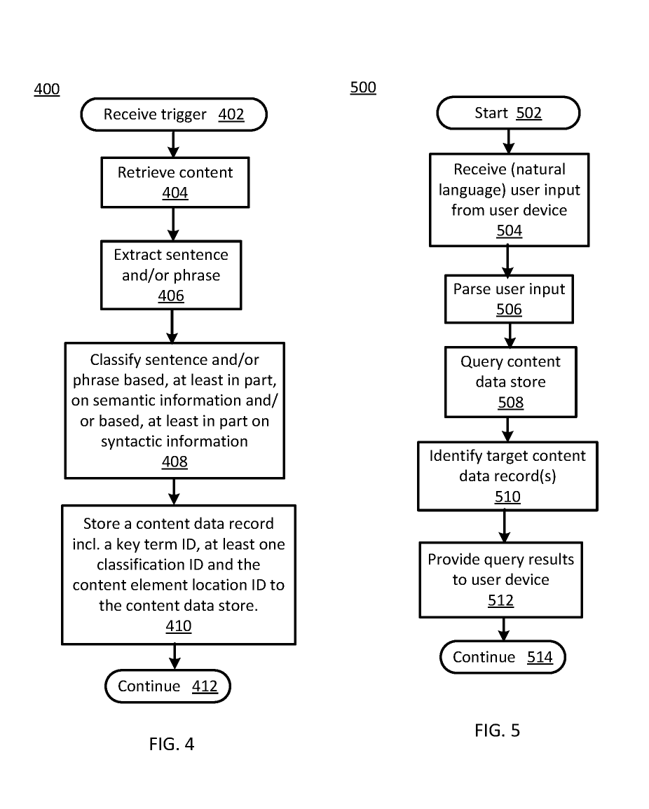

FIG. 4 is a flowchart 400 of content indexing operations according to various embodiments of the present disclosure. In particular, the flowchart 400 illustrates retrieving and indexing content, including key terms, semantic information and/or syntactic information. The operations may be performed, for example, by crawler logic 118, indexer logic 120 and/or NLU parser logic 122 of FIG. 1.

Operations of this embodiment may begin with receiving a trigger 402. For example, the trigger may correspond to an event. In another example, the trigger may correspond to expiry of a time interval. Operation 404 includes retrieving content. For example, the content may be retrieved from domain specific websites and/or storage related to a host system. A sentence and/or a phrase may be extracted at operation 406. For example, extracting the sentence and/or phrase may include identifying one or more key terms. The extracted sentence and/or phrase may be classified based, at least in part, on semantic information and/or syntactic information at operation 408. A content data record, including a key term identifier, at least one classification identifier and the content element location, may be stored to the content data store at operation 410. The at least one classification identifier may include a semantic classification identifier and/or a syntactic classification identifier. Program flow may then continue at operation 412.

The operations of flowchart 400 may be repeated intermittently and/or periodically in response to subsequent triggers, as described herein.

Thus, content may be indexed by a host system, e.g., host system 102 of FIG. 1. Content data records may then be stored to a content data store. The content data records may include content element location identifiers that may then be used to find the associated content in response to a user query.

FIG. 5 is a flowchart 500 of content retrieval operations according to various embodiments of the present disclosure. In particular, the flowchart 500 illustrates retrieving identified content in response to a user request (i.e., user query). The operations may be performed, for example, by NLU parser logic 122, host VA logic 124, query manager logic 126 and/or user VA logic 148 of FIG. 1.

Operations of this embodiment may begin with start 502. Operation 504 may include receiving a (natural language) user input from a user device. The user input may then be parsed at operation 506. For example, the user input may be parsed by NLU parser logic 122 of FIG. 1. A content data store may be queried at operation 508. For example, querying the content data store may include generating one or more query expansions, as described herein. Target content data record(s) may be identified at operation 510. For example, target content data records may include host key term identifiers and/or host classification identifiers and may be identified based, at least in part, on user key term identifiers and/or user classification identifiers. Query results may be provided to a user device at operation 512. For example, query results may include content element location identifiers associated with target content data. Program flow may then continue at operation 514.

Thus, content data may be provided to a user in response to a query that includes key terms, semantic information and/or syntactic information.

While the flowcharts of FIGS. 4 and 5 illustrate operations according various embodiments, it is to be understood that not all of the operations depicted in FIGS. 4 and 5 are necessary for other embodiments. In addition, it is fully contemplated herein that in other embodiments of the present disclosure, the operations depicted in FIGS. 4 and/or 5 and/or other operations described herein may be combined in a manner not specifically shown in any of the drawings, and such embodiments may include less or more operations than are illustrated in FIGS. 4 and 5 Thus, claims directed to features and/or operations that are not exactly shown in one drawing are deemed within the scope and content of the present disclosure.

Thus, crawler logic may be configured to retrieve content from a host system and indexer logic may be configured to extract words, phrases and/or sentences from the retrieved content. NLU parser logic may be configured to classify the words, phrases and/or sentences. The indexer logic and/or NLU parser logic are further configured to store content data, including one or more content data records, to a content data store.

Natural language queries may be received from a user device. NLU parser logic is further configured to parse the received user natural language query and to extract key terms, semantic information and/or syntactic information. The extracted key terms, semantic information and/or syntactic information may then be utilized by query manager logic to search the content data store. Utilizing the semantic information and/or syntactic information may yield relatively more directed search results compared to utilizing key terms alone. Thus, a user experience associated with the VA may be enhanced.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

The foregoing provides example system architectures and methodologies, however, modifications to the present disclosure are possible. The processor may include one or more processor cores and may be configured to execute system software. System software may include, for example, an operating system. Device memory may include I/O memory buffers configured to store one or more data packets that are to be transmitted by, or received by, a network interface.

The operating system (OS), e.g., OS 115, 145, may be configured to manage system resources and control tasks that are run on, e.g., host system 102 and/or user device 104. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units. The operating system and/or virtual machine may implement a protocol stack. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network.

Network 106 may include a packet switched network. Host system 102, user device 104 and/or network 106 may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, host system 102, user device 104 and/or network 106 may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, host system 102, user device 104 and/or network 106 may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, host system 102, user device 104 and/or network 106 may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Host system 102, user device 104 and/or network 106 may comply and/or be compatible with one or more communication specifications, standards and/or protocols. For example, host system 102, user device 104 and/or network 106 may comply and/or be compatible with IEEE Std 802.11™-2012 standard titled: IEEE Standard for Information technology—Telecommunications and information exchange between systems—Local and metropolitan area networks—Specific requirements Part 11: Wireless LAN Medium Access Control (MAC) and Physical Layer (PHY) Specifications, published in March 2012 and/or earlier and/or later and/or related versions of this standard, including, for example, IEEE Std 802.11ac™-2013, titled IEEE Standard for Information technology—Telecommunications and information exchange between systems, Local and metropolitan area networks-Specific requirements, Part 11: Wireless LAN Medium Access Control (MAC) and Physical Layer (PHY) Specifications; Amendment 4: Enhancements for Very High Throughput for Operation in Bands below 6 GHz, published by the IEEE, December 2013.

Host system 102, user device 104 and/or network 106 may comply and/or be compatible with one or more third generation (3G) telecommunication standards, recommendations and/or protocols that may comply and/or be compatible with International Telecommunication Union (ITU) Improved Mobile Telephone Communications (IMT)-2000 family of standards released beginning in 1992, and/or later and/or related releases of these standards. For example, host system 102, user device 104 and/or network 106 may comply and/or be compatible with one or more CDMA (Code Division Multiple Access) 2000 standard(s) and/or later and/or related versions of these standards including, for example, CDMA2000 1xRTT, 1× Advanced and/or CDMA2000 1xEV-DO (Evolution-Data Optimized): Release 0, Revision A, Revision B, Ultra Mobile Broadband (UMB). In another example, host system 102, user device 104 and/or network 106 may comply and/or be compatible with UMTS (Universal Mobile Telecommunication System) standard and/or later and/or related versions of these standards.

Host system 102, user device 104 and/or network 106 may comply and/or be compatible with one or more fourth generation (4G) telecommunication standards, recommendations and/or protocols that may comply and/or be compatible with ITU IMT-Advanced family of standards released beginning in March 2008, and/or later and/or related releases of these standards. For example, host system 102, user device 104 and/or network 106 may comply and/or be compatible with IEEE standard: IEEE Std 802.16-2012, title: IEEE Standard for Air Interface for Broadband Wireless Access Systems, released August 2012, and/or related and/or later versions of this standard. In another example, host system 102, user device 104 and/or network 106 may comply and/or be compatible with Long Term Evolution (LTE), Release 8, released March 2011, by the Third Generation Partnership Project (3GPP) and/or later and/or related versions of these standards, specifications and releases, for example, LTE-Advanced, Release 10, released April 2011.

Memory 122, 142 may each include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (HDL) may be used to specify circuit and/or logic implementation(s) for the various logic and/or circuitry described herein. For example, in one embodiment, the HDL may comply or be compatible with IEEE standard 62530-2011: SystemVerilog—Unified Hardware Design, Specification, and Verification Language, dated Jul. 7, 2011; IEEE Std 1800™-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a method, means for performing acts of the method, a device, or of an apparatus or system related to a natural language indexer for virtual assistants, as discussed below.

### Example 1

According to this example, there is provided an apparatus. The apparatus includes crawler logic, indexer logic, natural language understanding (NLU) parser logic, and a content data store. The crawler logic is to retrieve content. The indexer logic is to extract at least one of a sentence and/or a phrase and to identify a key term and a content element location identifier. The natural language understanding (NLU) parser logic is to classify the sentence and/or phrase based, at least in part, on semantic information and/or based, at least in part, on syntactic information. At least one of the indexer logic and/or the NLU parser logic is to store a content data record including a key term identifier, at least one of a semantic classification identifier and/or a syntactic classification identifier, and the content element location identifier to the content data store.

### Example 2

This example includes the elements of example 1, further including host virtual assistant logic to receive a user input from a user device, the NLU parser logic further to parse the user input.

### Example 3

This example includes the elements of example 2, further including query manager logic to receive the parsed user input and to query the content data store.

### Example 4

This example includes the elements of example 3, wherein the query manager logic is to construct a plurality of queries, each query including a respective query expansion.

### Example 5

This example includes the elements of example 3, wherein the query manager logic is to identify a target content data record based, at least in part, on the parsed user input.

### Example 6

This example includes the elements of example 2, wherein the host virtual assistant logic is to provide a query result based, at least in part, on semantic data, to the user device.

### Example 7

This example includes the elements according to any one of examples 1 or 2, wherein the crawler logic, the indexer logic and the NLU parser logic are to repeat their respective operations to update the content data store at least one of intermittently and/or periodically.

### Example 8

This example includes the elements of example 2, wherein the NLU parser logic is to parse the user input using at least one of a constituency parsing technique and/or a dependency parsing technique.

### Example 9

This example includes the elements according to any one of examples 1 or 2, wherein the semantic information includes one or more of a sentiment descriptor, an adjective descriptor, a synonym to the key term, a frequency that the key term appears in a content element, a relative importance of the key term in the content element and/or a location of the key term in the content element and the syntactic information includes one or more of word order and/or part of speech.

### Example 10

This example includes the elements according to any one of examples 1 or 2, wherein the crawler logic is to retrieve content from one or more of a host website, a host system memory and/or a host file system.

### Example 11

This example includes the elements according to any one of examples 1 or 2, wherein the crawler logic, the indexer logic and the NLU parser logic are to repeat their respective operations to update the content data store in response to an event.

### Example 12

According to this example, there is provided a method. The method includes retrieving content, extracting at least one of a sentence and/or a phrase, identifying a key term and a content element location, classifying the sentence and/or phrase, and storing a content data record. The content is retrieved by crawler logic. At least one of the sentence and/or the phrase is extracted by indexer logic. The key term and the content element location identifier is identified by indexer logic. The sentence and/or the phrase is classified, by natural language understanding (NLU) parser logic, based, at least in part, on semantic information and/or based, at least in part, on syntactic information. The content data record is stored to a content data store by at least one of the indexer logic and/or the NLU parser logic. The content data record includes a key term identifier, at least one of a semantic classification identifier and/or a syntactic classification identifier, and the content element location identifier.

### Example 13

This example includes the elements of example 12, and further includes receiving, by host virtual assistant logic, a user input from a user device and parsing, by the NLU parser logic, the user input.

### Example 14

This example includes the elements of example 13, and further includes receiving, by query manager logic, the parsed user input and querying, by the query manager logic, the content data store.

### Example 15

This example includes the elements of example 14, and further includes constructing, by the query manager logic, a plurality of queries, each query includes a respective query expansion.

### Example 16

This example includes the elements of example 14, and further includes identifying, by the query manager logic, a target content data record based, at least in part, on the parsed user input.

### Example 17

This example includes the elements of example 13, and further includes providing, by the host virtual assistant logic, a query result based, at least in part, on semantic data, to the user device.

### Example 18

This example includes the elements of example 12, and further includes repeating, by the crawler logic, the indexer logic and the NLU parser logic, their respective operations to update the content data store at least one of intermittently and/or periodically.

### Example 19

This example includes the elements of example 13, wherein parsing, by the NLU parser logic, the user input includes at least one of a constituency parsing technique and/or a dependency parsing technique.

### Example 20

This example includes the elements of example 12, wherein the semantic information includes one or more of a sentiment descriptor, an adjective descriptor, a synonym to the key term, a frequency that the key term appears in a content element, a relative importance of the key term in the content element and/or a location of the key term in the content element and the syntactic information includes one or more of word order and/or part of speech.

### Example 21

This example includes the elements of example 12, wherein retrieving, by the crawler logic, content includes retrieving the content from one or more of a host website, a host system memory and/or a host file system.

### Example 22

This example includes the elements of example 12, and further includes repeating, by the crawler logic, the indexer logic and the NLU parser logic, their respective operations to update the content data store in response to an event.

### Example 23

According to this example, there is provided a system. The system includes a processor, a communication interface, a memory, crawler logic, indexer logic, natural language understanding (NLU) parser logic, and a content data store. The crawler logic is to retrieve content. The indexer logic is to extract at least one of a sentence and/or a phrase and to identify a key term and a content element location identifier. The natural language understanding (NLU) parser logic is to classify the sentence and/or phrase based, at least in part, on semantic information and/or based, at least in part, on syntactic information. At least one of the indexer logic and/or the NLU parser logic is to store a content data record including a key term identifier, at least one of a semantic classification identifier and/or a syntactic classification identifier, and the content element location identifier to the content data store.

### Example 24

This example includes the elements of example 23, further including host virtual assistant logic to receive a user input from a user device, the NLU parser logic further to parse the user input.

### Example 25

This example includes the elements of example 24, further including query manager logic to receive the parsed user input and to query the content data store.

### Example 26

This example includes the elements of example 25, wherein the query manager logic is to construct a plurality of queries, each query includes a respective query expansion.

### Example 27

This example includes the elements of example 25, wherein the query manager logic is to identify a target content data record based, at least in part, on the parsed user input.

### Example 28

This example includes the elements of example 24, wherein the host virtual assistant logic is to provide a query result based, at least in part, on semantic data, to the user device.

### Example 29

This example includes the elements according to any one of examples 23 or 24, wherein the crawler logic, the indexer logic and the NLU parser logic are to repeat their respective operations to update the content data store at least one of intermittently and/or periodically.

### Example 30

This example includes the elements of example 24, wherein the NLU parser logic is to parse the user input using at least one of a constituency parsing technique and/or a dependency parsing technique.

### Example 31

This example includes the elements according to any one of examples 23 or 24, wherein the semantic information includes one or more of a sentiment descriptor, an adjective descriptor, a synonym to the key term, a frequency that the key term appears in a content element, a relative importance of the key term in the content element and/or a location of the key term in the content element and the syntactic information includes one or more of word order and/or part of speech.

### Example 32

This example includes the elements according to any one of examples 23 or 24, wherein the crawler logic is to retrieve content from one or more of a host website, the memory and/or a host file system.

### Example 33

This example includes the elements according to any one of examples 23 or 24, wherein the crawler logic, the indexer logic and the NLU parser logic are to repeat their respective operations to update the content data store in response to an event.

### Example 34

According to this example, there is provided a computer readable storage device. The device has stored thereon instructions that when executed by one or more processors result in the following operations. The operations include retrieving content, extracting at least one of a sentence and/or a phrase, identifying a key term and a content element location identifier, classifying the sentence and/or phrase based, at least in part, on semantic information and/or based, at least in part, on syntactic information, and storing a content data record to a content data store. The content data record includes a key term identifier, at least one of a semantic classification identifier and/or a syntactic classification identifier, and the content element location identifier.

### Example 35

This example includes the elements of example 34, wherein the instructions that when executed by one or more processors result in the following additional operations including receiving a user input from a user device and parsing, by the NLU parser logic, the user input.

### Example 36

This example includes the elements of example 35, wherein the instructions that when executed by one or more processors result in the following additional operations including receiving the parsed user input and querying the content data store.

### Example 37

This example includes the elements of example 36, wherein the instructions that when executed by one or more processors result in the following additional operations including constructing a plurality of queries, each query including a respective query expansion.

### Example 38

This example includes the elements of example 36, wherein the instructions that when executed by one or more processors result in the following additional operations including identifying a target content data record based, at least in part, on the parsed user input.

### Example 39

This example includes the elements of example 35, wherein the instructions that when executed by one or more processors result in the following additional operations including providing a query result based, at least in part, on semantic data, to the user device.

### Example 40

This example includes the elements according to any one of examples 34 or 35, wherein the instructions that when executed by one or more processors result in the following additional operations including repeating the operations to update the content data store at least one of intermittently and/or periodically.

### Example 41

This example includes the elements of example 35, wherein parsing the user input includes at least one of a constituency parsing technique and/or a dependency parsing technique.

### Example 42

This example includes the elements according to any one of examples 34 or 35, wherein the semantic information includes one or more of a sentiment descriptor, an adjective descriptor, a synonym to the key term, a frequency that the key term appears in a content element, a relative importance of the key term in the content element and/or a location of the key term in the content element and the syntactic information includes one or more of word order and/or part of speech.

### Example 43

This example includes the elements according to any one of examples 34 or 35, wherein retrieving content includes retrieving the content from one or more of a host website, a host system memory and/or a host file system.

### Example 44

This example includes the elements according to any one of examples 34 or 35, wherein the instructions that when executed by one or more processors result in the following additional operations including repeating the operations to update the content data store in response to an event.

### Example 45

According to this example, there is provided a device. The device includes means for retrieving, by crawler logic, content. The system further includes means for extracting, by indexer logic, at least one of a sentence and/or a phrase. The system further includes means for identifying, by the indexer logic, a key term and a content element location identifier. The system further includes means for classifying, by natural language understanding (NLU) parser logic, the sentence and/or phrase based, at least in part, on semantic information and/or based, at least in part, on syntactic information. The system further includes means for storing, by at least one of the indexer logic and/or the NLU parser logic, a content data record to a content data store. The content data record includes a key term identifier, at least one of a semantic classification identifier and/or a syntactic classification identifier and the content element location identifier.

### Example 46

This example includes the elements of example 45, further including means for receiving, by host virtual assistant logic, a user input from a user device and means for parsing, by the NLU parser logic, the user input.

### Example 47

This example includes the elements of example 46, further including means for receiving, by query manager logic, the parsed user input and means for querying, by the query manager logic, the content data store.

### Example 48

This example includes the elements of example 47, further including means for constructing, by the query manager logic, a plurality of queries, each query including a respective query expansion.

### Example 49

This example includes the elements of example 47, further including means for identifying, by the query manager logic, a target content data record based, at least in part, on the parsed user input.

### Example 50

This example includes the elements of example 46, further including means for providing, by the host virtual assistant logic, a query result based, at least in part, on semantic data, to the user device.

### Example 51

This example includes the elements according to any one of examples 45 or 46, further including means for repeating, by the crawler logic, the indexer logic and the NLU parser logic, their respective operations to update the content data store at least one of intermittently and/or periodically.

### Example 52

This example includes the elements of example 46, wherein parsing, by the NLU parser logic, the user input includes at least one of a constituency parsing technique and/or a dependency parsing technique.

### Example 53

This example includes the elements according to any one of examples 45 or 46, wherein the semantic information includes one or more of a sentiment descriptor, an adjective descriptor, a synonym to the key term, a frequency that the key term appears in a content element, a relative importance of the key term in the content element and/or a location of the key term in the content element and the syntactic information includes one or more of word order and/or part of speech.

### Example 54

This example includes the elements according to any one of examples 45 or 46, wherein retrieving, by the crawler logic, content includes retrieving the content from one or more of a host website, a host system memory and/or a host file system.

### Example 55

This example includes the elements according to any one of examples 45 or 46, further including means for repeating, by the crawler logic, the indexer logic and the NLU parser logic, their respective operations to update the content data store in response to an event.

### Example 56

According to this example, there is provided a system. The system includes at least one device arranged to perform the method according to any one of examples 12 through 22.

### Example 57

According to this example, there is provided a device. The device includes means to perform the method according to any one of examples 12 through 22.

### Example 58

According to this example, there is provided a computer readable storage device. The computer readable storage device has stored thereon instructions that when executed by one or more processors result in the following operations including the method according to any one of examples 12 through 22.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1-24. (canceled)

25. An apparatus comprising:
crawler logic to retrieve content;
indexer logic to extract at least one of a sentence and/or a phrase and to identify a key term and a content element location identifier;
natural language understanding (NLU) parser logic to classify the sentence and/or phrase based, at least in part, on semantic information and/or based, at least in part, on syntactic information; and
a content data store, at least one of the indexer logic and/or the NLU parser logic to store a content data record comprising a key term identifier, at least one of a semantic classification identifier and/or a syntactic classification identifier and the content element location identifier to the content data store.

26. The apparatus of claim 25, further comprising host virtual assistant logic to receive a user input from a user device, the NLU parser logic further to parse the user input.

27. The apparatus of claim 26, further comprising query manager logic to receive the parsed user input and to query the content data store.

28. The apparatus of claim 27, wherein the query manager logic is to construct a plurality of queries, each query comprising a respective query expansion.

29. The apparatus of claim 27, wherein the query manager logic is to identify a target content data record based, at least in part, on the parsed user input.

30. The apparatus of claim 26, wherein the host virtual assistant logic is to provide a query result based, at least in part, on semantic data, to the user device.

31. The apparatus of claim 25, wherein the crawler logic, the indexer logic and the NLU parser logic are to repeat their respective operations to update the content data store at least one of intermittently and/or periodically.

32. A method comprising:
retrieving, by crawler logic, content;
extracting, by indexer logic, at least one of a sentence and/or a phrase;
identifying, by the indexer logic, a key term and a content element location identifier;
classifying, by natural language understanding (NLU) parser logic, the sentence and/or phrase based, at least in part, on semantic information and/or based, at least in part, on syntactic information; and
storing, by at least one of the indexer logic and/or the NLU parser logic, a content data record to a content data store, the content data record comprising a key term identifier, at least one of a semantic classification identifier and/or a syntactic classification identifier and the content element location identifier.

33. The method of claim 32, further comprising receiving, by host virtual assistant logic, a user input from a user device and parsing, by the NLU parser logic, the user input.

34. The method of claim 33, further comprising receiving, by query manager logic, the parsed user input and querying, by the query manager logic, the content data store.

35. The method of claim 34, further comprising constructing, by the query manager logic, a plurality of queries, each query comprising a respective query expansion.

36. The method of claim 34, further comprising identifying, by the query manager logic, a target content data record based, at least in part, on the parsed user input.

37. The method of claim 33, further comprising providing, by the host virtual assistant logic, a query result based, at least in part, on semantic data, to the user device.

38. The method of claim 32, further comprising repeating, by the crawler logic, the indexer logic and the NLU parser logic, their respective operations to update the content data store at least one of intermittently and/or periodically.

39. A system comprising:
a processor;
a communication interface;
a memory;
crawler logic to retrieve content;
indexer logic to extract at least one of a sentence and/or a phrase and to identify a key term and a content element location identifier;
natural language understanding (NLU) parser logic to classify the sentence and/or phrase based, at least in part, on semantic information and/or based, at least in part, on syntactic information; and
a content data store, at least one of the indexer logic and/or the NLU parser logic to store a content data record comprising a key term identifier, at least one of a semantic classification identifier and/or a syntactic classification identifier and the content element location identifier to the content data store.

40. The system of claim 39, further comprising host virtual assistant logic to receive a user input from a user device, the NLU parser logic further to parse the user input.

41. The system of claim 40, further comprising query manager logic to receive the parsed user input and to query the content data store.

42. The system of claim 41, wherein the query manager logic is to construct a plurality of queries, each query comprising a respective query expansion.

43. The system of claim 41, wherein the query manager logic is to identify a target content data record based, at least in part, on the parsed user input.

44. The system of claim 40, wherein the host virtual assistant logic is to provide a query result based, at least in part, on semantic data, to the user device.

45. The system of claim 39, wherein the crawler logic, the indexer logic and the NLU parser logic are to repeat their respective operations to update the content data store at least one of intermittently and/or periodically.
